(19) United States
(12) Patent Application Publication
(10) Pub. No.: US 2025/0321108 A1
(43) Pub. Date: Oct. 16, 2025

(54) SYSTEMS AND METHODS FOR RISK-INFORMED ROUTE PLANNING AND GUIDANCE

(71) Applicant: UT-Battelle, LLC, Oak Ridge, TN (US)

(72) Inventors: Robert N. Stewart, Oak Ridge, TN (US); Aaron T. Myers, Oak Ridge, TN (US); S. Carter Christopher, Oak Ridge, TN (US); Gautam Thakur, Knoxville, TN (US); Jordan A. Burdette, Oak Ridge, TN (US); Junghoon Chae, Knoxville, TN (US); Steven K. Peterson, Oak Ridge, TN (US)

(21) Appl. No.: 19/175,346

(22) Filed: Apr. 10, 2025

Related U.S. Application Data
(60) Provisional application No. 63/633,383, filed on Apr. 12, 2024.

(51) Int. Cl. G01C 21/34; G01C 21/36

(52) U.S. Cl. CPC G01C 21/3461; G01C 21/3667

(57) ABSTRACT

A system and method for managing road transportation of sensitive materials using structured representations of perceived risk. The system includes a memory storing road-segment risk-perception information comprising risk labels, exposure durations, and user-defined risk tolerances. A routing interface receives a route-related request, and a data processing apparatus generates routing instructions based on comparisons of exposure durations, avoidance durations, or risk acceptability thresholds. Risk-feature maps are generated from geographic data using spatial data processing techniques, and risk labels are assigned to road segments based on intersections with risk features. The system enables user input via a graphical interface to adjust tolerances or avoidance values for distinct risk types, with visual feedback provided on aggregate temporal avoidance. The approach permits integration of subject-matter expert perception data into routing decisions by expressing risk avoidance as a temporal cost, allowing risk-informed route evaluation using conventional time-based routing algorithms.

### BACKGROUND OF THE INVENTION

The present disclosure relates generally to transportation and routing technologies, and more specifically to computer-implemented systems and methods for route planning, guidance, or evaluation that incorporate context-specific risk in addition to conventional factors such as distance or time.

Conventional transportation routing systems typically evaluate and compare route alternatives based on physical or logistical factors such as distance and travel time, as well as predefined avoidance criteria such as avoiding toll roads, population centers, or legally designated no-travel zones. In many cases, these features are incorporated to improve travel efficiency. Some advanced systems may incorporate additional data sources, such as real-time traffic, weather, or road closures.

In certain transportation scenarios, additional considerations may arise that are not easily captured using conventional routing criteria. These may include concerns about passing through areas with elevated security risks, limited access to emergency services, degraded infrastructure, or other situational factors that could influence the desirability of a route. In some cases, such concerns may be based on mission-specific objectives, operational constraints, or judgments informed by experience or evolving conditions.

Many of the factors that may influence route selection in these scenarios are not readily captured through conventional data sources or probabilistic models. In particular, so-called Black Swan or Gray Swan events—such as civil unrest, infrastructure collapse, or sudden loss of support services—may lack sufficient historical precedent to support statistical risk estimation. These events are characterized not only by their rarity, but also by the disproportionate consequences they may carry in the event of failure. Moreover, the relevance of a given risk factor may vary depending on the mission type, operational constraints, or perceived vulnerabilities, making it difficult to define universal thresholds or rules. As a result, route decisions in such cases often rely on the accumulated knowledge of experienced planners or internal guidelines, rather than structured, machine-interpretable criteria.

Accordingly, there remains a need for computer-implemented systems and methods that enable transportation routes to be evaluated and adjusted based on structured representations of context-specific risk, particularly in cases where conventional models based on distance, time, or regulatory constraints are insufficient. Such systems would ideally allow operators, planners, or automated tools to account for perceptions of vulnerability, regardless of whether those perceptions are based on data, experience, or operational objectives, within a consistent and repeatable routing framework.

### SUMMARY OF THE INVENTION

Systems and methods for managing road transportation of sensitive materials through a geographic region are provided. The disclosed systems and methods support routing decisions that incorporate informed risk perceptions using a combination of road-segment risk labels, exposure durations, ordinal risk values, and user-defined routing preferences. A unified framework enables route evaluations that go beyond traditional travel-time metrics to account for perceived vulnerabilities and user-defined tolerances. The system and method operate flexibly across manual and autonomous vehicle platforms and may be deployed locally or in distributed computing environments.

In one aspect, the system includes a memory configured to store road-segment risk-perception information for each of a plurality of road segments within the geographic region. The risk-perception information includes, for each road segment, one or more risk labels identifying respective types of risk to which the sensitive materials would be exposed during transport.

The system further includes a routing interface configured to receive, from a user, a request for route information related to the transportation of the sensitive materials. The route comprises a plurality of the road segments and is configured such that at least some segments are individually avoidable by exiting the route at one end of the segment and rejoining it at the other end via one or more off-route roads.

A data processing apparatus is communicatively coupled with the memory and routing interface. The data processing apparatus is configured to retrieve a portion of the risk-perception information associated with the requested route, generate a routing instruction based on that information, and output the instruction via the routing interface for use by a vehicle operator.

In one embodiment, the road-segment risk-perception information includes exposure durations and avoidance durations associated with each risk label. The data processing apparatus may compare these durations to guide routing decisions.

In another embodiment, each risk label is associated with an ordinal value on an acceptability scale. A user-defined threshold on this scale may be used by the data processing apparatus to evaluate route acceptability and select route segments.

In still another embodiment, the system derives a statistical range of perceived risk values for each risk label from multiple evaluations. The statistical range may be presented to a user to support interactive threshold setting or selection of a risk posture.

In yet another embodiment, the routing interface includes a graphical user interface having visual feedback components and user-adjustable controls for defining tolerance levels across multiple risk types.

In even another embodiment, the system supports autonomous vehicles by communicating routing instructions to onboard controller circuitry via a network interface.

In a further embodiment, the data processing apparatus is configured to generate a composite temporal avoidance profile that aggregates the effects of multiple risk types over the route, enabling comparative evaluation of candidate routes based on combined risk-informed metrics.

In a further embodiment, the data processing apparatus is implemented locally on the vehicle, remotely on an external computing system, or across distributed systems.

In another aspect, a method is provided. The method includes storing road-segment risk-perception information for a plurality of road segments; receiving a user-initiated request via the routing interface for route guidance; retrieving a subset of the risk-perception information based on the requested route; generating a routing instruction using the retrieved information; and outputting the instruction via the routing interface.

In one embodiment of this aspect, generating the routing instruction includes comparing exposure durations and avoidance durations for one or more route segments.

In another embodiment, the method includes storing ordinal values on an acceptability scale for respective risk labels and applying user-defined thresholds to determine route suitability.

In still another embodiment, the method includes presenting statistical ranges of perceived risk values and enabling a user to select a threshold within a displayed range.

The current aspects provide a system and method for efficient and safe routing of sensitive materials based on risk perception, enabling route selection informed by expert judgment and user-defined tolerances. Individual components and features of the system and method may be combined in various configurations to suit different use cases or deployment environments.

These and other objects, advantages, and features of the invention will be more fully understood and appreciated by reference to the description of the current aspects and the drawings.

Before the aspects of the invention are explained in detail, it is to be understood that the invention is not limited to the details of operation or to the details of construction and the arrangement of the components set forth in the following description or illustrated in the drawings. The invention may be implemented in various other aspects and is capable of being practiced or being carried out in alternative ways not expressly disclosed herein. Also, it is to be understood that the phraseology and terminology used herein are for the purpose of description and should not be regarded as limiting. The use of “including” and “comprising” and variations thereof is meant to encompass the items listed thereafter and equivalents thereof as well as additional items and equivalents thereof. Further, enumeration may be used in the description of various aspects. Unless otherwise expressly stated, the use of enumeration should not be construed as limiting the invention to any specific order or number of components. Nor should the use of enumeration be construed as excluding from the scope of the invention any additional steps or components that might be combined with or into the enumerated steps or components.

### BRIEF DESCRIPTION OF THE DRAWINGS

FIG. 1 is a diagrammatic view illustrating segment-level temporal avoidance values computed based on exposure duration to a risk type along a route.

FIG. 2 is a diagrammatic comparison of multiple safe haven buffer configurations, including as-the-crow-flies, drive-time, and network-based representations.

FIG. 3 is a schematic illustration showing individual road segments and their association with one or more out-of-service area (OSA) risk types.

FIG. 4 is a diagrammatic view illustrating the application of area-type and line-type risk features to a route corridor, including example sources such as crime zones, tunnels, bridges, and railroad crossings.

FIG. 5 is a schematic illustration of segment-level labeling in association with overlapping or compound risk features.

FIG. 6 is a schematic illustration showing multiple segments contributing to a single risk exposure event involving overlapping risk features and durations.

FIG. 7 is a diagrammatic view of the process of computing temporal avoidance values based on exposure across multiple route segments and multiple risk types.

FIG. 8 is a schematic illustration of segment-level labeling with composite risk profiles that include risk source, exposure duration, and calculated temporal avoidance values.

FIG. 9 is a diagrammatic illustration of the aggregation of labeled child risk segments back to original or parent road segments.

FIGS. 10A-10D are graphical views illustrating route-level attribute distributions including population exposure, route risk scores, and proximity to services such as police or emergency response.

FIG. 10E is a schematic illustration of a user interface configured to display and adjust multiple risk category thresholds using a temporal avoidance slider interface.

FIG. 11 is a diagrammatic view of a multi-tier acceptability scale configured to support route selection based on user-indicated or expert-defined thresholds of unacceptability.

FIG. 12 is a schematic illustration of various sensor inputs, service features, and contextual data sources that may inform a route's perceived risk or associated scores.

FIG. 13 is a system-level block diagram of a risk-aware routing system including memory, user interface, data processing apparatus, risk map layers, and associated segment-level route data.

### DETAILED DESCRIPTION OF THE CURRENT EMBODIMENTS

The present disclosure provides a system and method for managing road transportation of sensitive materials using a structured, risk-informed approach to route planning, guidance, and evaluation. Unlike conventional routing systems that prioritize metrics such as travel time, distance, or regulatory constraints, the disclosed system enables route decision-making based on structured representations of perceived risk. These representations are generated from a combination of expert-informed knowledge, mission-specific operational constraints, and contextual indicators relevant to the transportation scenario. Some embodiments feature the ability to leverage “temporal avoidance” as a unifying metric of risk perception—defined herein as a time-based expression of the detour or delay that a planner or operator would be willing to incur in order to avoid a given vulnerability. By converting diverse risk perceptions into a common time unit, the system enables integration of perceived threats into routing algorithms that operate on familiar, quantitative foundations such as segment-level travel time or total route duration. This allows planners and automated systems alike to evaluate routes not just by how quickly and efficiently they reach a destination, but to factor in, based on suitable criteria, how well they avoid exposures to perceived hazards—regardless of whether those hazards are readily quantifiable through historical data or traditional risk analysis.

The disclosure enables transportation routes to be planned, evaluated, and adjusted based on structured representations of risk that reflect both quantitative and qualitative sources of information. This can include perceived vulnerabilities identified by subject matter experts, operational constraints related to infrastructure or mission type, and contextual indicators such as environmental, geographic, or service-related features.

Rather than relying solely on empirical data or historical failure rates, some embodiments introduce a framework in which perceived risk is expressed as a temporal cost—termed “temporal avoidance”—that reflects the extent to which a user would be willing to deviate from a route to avoid a particular type of risk. These time-based representations of risk can be derived from data, elicited from expert opinion (e.g., via surveys), or both, and can be integrated into routing systems that evaluate route options using conventional time-based metrics.

In some embodiments, route evaluation incorporates context-aware analysis of geographic data using risk-feature maps, which are spatial representations of risk derived from underlying features such as infrastructure gaps, service availability zones, population density, or mission-specific constraints. These spatial risk features may be represented as point-based, line-based, or area-based geometries, and can be algorithmically intersected with road networks to identify segments subject to elevated risk. The resulting associations can then be used to assign risk labels to road segments and to generate composite risk profiles that inform routing instructions. In such embodiments, risk may be inferred from the physical overlap of route segments with environmental or operational risk indicators, rather than requiring user-defined perceptions or expert-elicited avoidance values.

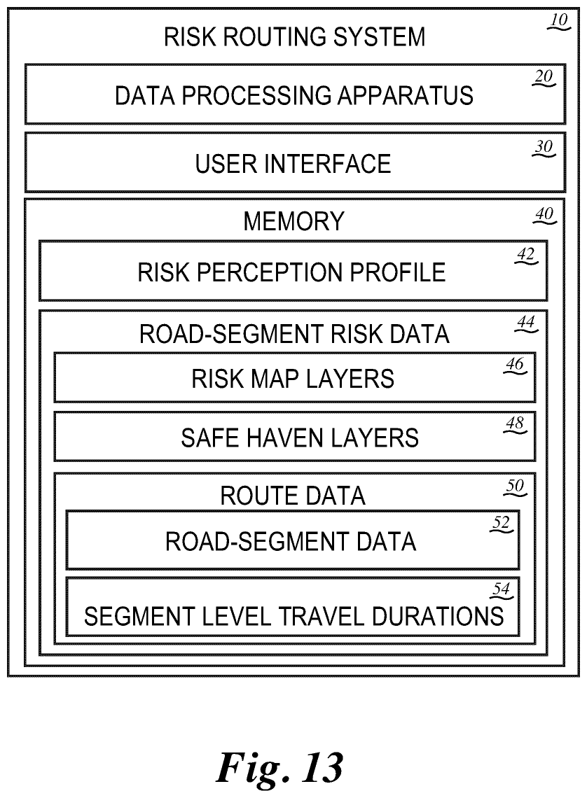

Referring now to FIG. 13, a schematic diagram is shown illustrating a high-level architectural view of an exemplary risk routing system 10 according to one embodiment of the disclosure. In the depicted embodiment, the risk routing system 10 includes three principal subsystems: a data processing apparatus 20, a user interface 30, and a memory 40. Each of these subsystems is shown as a component block within the system, with the memory 40 further subdivided to illustrate various types of stored data structures or information layers utilized by the risk routing system 10.

The data processing apparatus 20 may include one or more processors, microcontrollers, computing nodes, or other programmable circuitry configured to perform the evaluation, inference, and instruction generation tasks described herein, including but not limited to: route assessment, segment labeling, risk scoring, route selection, avoidance duration calculation, risk threshold comparison, and output instruction generation. The data processing apparatus 20 may be implemented using a standalone computing system, an embedded computing module onboard a vehicle, a remote server, or a distributed computing environment spanning multiple physical or virtual machines. In some embodiments, different functional modules of the data processing apparatus 20 may operate on separate hardware nodes, such that route evaluation and segment labeling are performed in the cloud while threshold selection or user interaction handling is performed locally on a vehicle system or operator terminal. The data processing apparatus 20 may further comprise or interface with specialized hardware for geospatial computation, artificial intelligence (AI) inference, or sensor data fusion, depending on deployment context. In addition, the data processing apparatus 20 may execute software instructions from one or more memory elements associated with the memory 40, which may include volatile and non-volatile memory components and may store code libraries, risk model parameters, and operational configurations.

The user interface 30 may include a graphical user interface (GUI) or other routing interface through which a user may submit route-related requests and receive corresponding routing outputs. As used herein, the terms “routing interface” and “graphical user interface” may be used interchangeably to describe any interface configured to receive user input regarding route parameters, preferences, or constraints, and to display route-related outputs including annotated route maps, risk profile indicators, temporal avoidance summaries, or turn-by-turn routing instructions. In some embodiments, the user interface 30 may be web-based or implemented as a web-like interface, such as a browser-accessible dashboard or a standalone mobile or desktop application. The interface may be accessed via a remote planning terminal, an in-vehicle display system, or a network-connected device. The user interface 30 may further support interactive input elements such as sliders, toggles, or drop-down selectors for adjusting risk tolerance thresholds, viewing aggregated exposure metrics, or customizing avoidance preferences. In some embodiments, the interface may be operated via a touchscreen, voice command system, physical controls integrated into a vehicle dashboard, or other hardware-based input mechanisms suitable for in-transit or field-based operation.

The memory 40 may include one or more data stores, databases, or structured memory systems configured to store road-segment risk-perception information for a plurality of road segments within the geographic region. As used herein, “road-segment risk-perception information” refers to structured data associated with individual road segments that includes, for each segment, one or more risk labels identifying respective types of risk (e.g., infrastructure degradation, service outages, proximity to high-risk facilities), along with corresponding exposure durations, avoidance durations, ordinal acceptability values, or other metadata. The memory 40 may be implemented using local memory devices co-located with the data processing apparatus 20, remote or cloud-based storage services, or a distributed data architecture combining both local and remote components. In some embodiments, the memory 40 may store precomputed risk-feature maps, segment-to-risk associations, and derived temporal avoidance values, while in other embodiments, these may be computed or refreshed dynamically based on real-time inputs. The memory 40 may further support periodic updates, data synchronization with third-party sources, or rule-based storage of mission-specific risk criteria.

In the current embodiment, as illustrated in FIG. 13, the memory 40 is shown as including multiple internal data structures. These include a risk perception profile 42, a road-segment risk data module 44 (which itself contains risk map layers 46), a safe haven layers module 48, and a route data structure 50. The route data 50 may include road-segment data 52 and segment-level travel durations 54. These modules may be implemented as logically distinct components within a unified memory system or may be physically distributed across multiple systems. In operation, these structures support route evaluation, segment-level scoring, and the generation of risk-informed routing instructions, as described in further detail below.

The risk perception profile 42 may represent user-defined or expert-elicited parameters reflecting tolerance levels, avoidance thresholds, or relative weightings of different risk types. These settings may be configured directly by a user through the graphical interface, derived from prior route selection behavior, or loaded from institutional or mission-specific policy templates. In some embodiments, the profile 42 may include default templates based on user roles or predefined risk scenarios (e.g., transport under threat of natural disaster, civil unrest, or medical evacuation). The data processing apparatus 20 may access the risk perception profile 42 to interpret user-defined routing preferences and incorporate them into route scoring or instruction generation logic.

In different configurations, the risk perception profile 42 may quantify routing preferences using one of multiple formats. In some implementations, each risk type is associated with a temporal avoidance value, representing the maximum amount of time a user would be willing to detour in order to avoid that risk type. In other implementations, routing preferences are expressed using ordinal values on an acceptability scale—such as a Likert scale—where each risk type is rated according to perceived acceptability or severity. In either case, the resulting profile allows the system to perform route evaluation using structured criteria that reflect both user tolerances and contextual risk indicators.

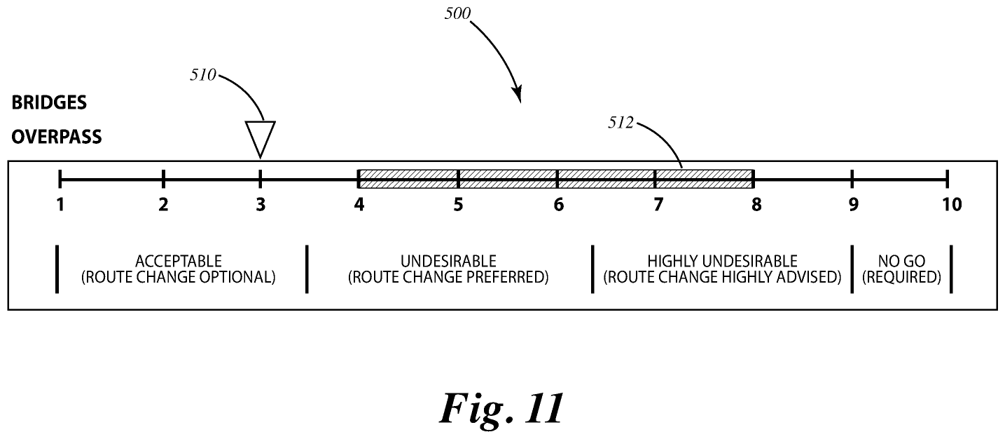

In some embodiments, risk labels used within the system are organized into a hierarchical structure comprising general categories and corresponding sub-categories. Each general category—such as Public Unrest, Weather, Infrastructure, or Communications—may be further divided into more granular sub-categories that reflect specific risk scenarios, such as “Snow and Ice,” “Unusual Unrest,” or “Low Tunnel Clearance.” This structure enables nuanced distinction between different forms of a risk type while preserving interoperability across route evaluation logic. In some configurations, average perceived severity scores may be associated with each sub-category based on historical evaluations or crowd-sourced expert input. A representative mapping of general categories, sub-categories, and corresponding average severity scores is shown in Table 1. These scores may be used to inform the default configuration of statistical ranges (e.g., statistical range 512 in FIG. 11), guide risk threshold selection, or initialize user profiles. By incorporating both coarse and fine-grained descriptors, the system supports both operational clarity and flexible customization of risk perception profiles.

TABLE 1

| General | | |
|---|---|---|
| Category | Sub-Category | Score |
| Bridges | Overpass | 2.2 |
| | Underpass | 2.3 |
| | Over ground | 2.1 |
| | Over water | 4.3 |
| Railroad | Typical clearance | 2.3 |
| Crossings | Low clearance | 9.9 |
| Congestion | Heavy stops and | 8.5 |
| | long waits | |
| | Extended stop and go | 8.1 |
| | Short stop and go | 6.5 |
| Cell | Spotty | 4.2 |
| Coverage | Frequent drop out | 7.7 |
| | Continuous no-service | 9.5 |
| Satellite | Spotty | 4.1 |
| Coverage | Frequent drop out | 4.2 |
| | Continuous no-service | 8.3 |
| Elevation | Urban canyons | 7.8 |
| | Natural above | 8.8 |
| | Natural below | 3.1 |
| Road | Above average | 5.5 |
| Conditions | accident rates | |
| | Rough surface | 6.2 |
| | Winding narrow roads | 8.1 |
| | Poor shoulders | 7.4 |
| Population | Dense urban | 6.6 |
| | Suburbs | 5.1 |
| | Rural | 5.3 |
| Public | High police | 8.9 |
| Unrest | Unusual events | 9.7 |
| Weather | Snow and ice | 9.9 |
| | Heavy rain/flooding | 9.1 |
| | High winds (30+ mph) | 9.3 |
| Security | 5-10 minutes | 1.2 |
| Services | 10-20 minutes | 3.4 |
| | More than 20 minutes | 5.5 |
| Medical | 5-10 minutes | 1.1 |
| Services | 10-20 minutes | 1.2 |
| | More than 20 minutes | 3.3 |
| Mechanical | 5-10 minutes | 1.4 |
| Services | 10-20 minutes | 1.6 |
| | More than 20 minutes | 2.5 |
| Safe | 5-10 minutes | 2.1 |
| Havens | 10-60 minutes | 3.6 |
| | More than 60 minutes | 6.0 |
| Tunnels | Larger arterial | 6.5 |
| | Small | 8.9 |

In practice, the assignment of general and sub-category risk labels to route segments may be informed by a combination of static, semi-dynamic, and real-time data sources. For instance, weather-related sub-categories such as “Snow and Ice” or “Flooding” may be populated using feeds from government meteorological services, while “Unusual Unrest” or “Out of Range” designations may be informed by incident databases, mobile network APIs, or crowd-sourced intelligence. The system may ingest these data sources through configurable ingestion pipelines, which convert heterogeneous input formats (e.g., shapefiles, sensor feeds, alerts, or service logs) into structured features compatible with the risk-feature map layers 46. Each such layer is tagged with a corresponding risk label from the defined general/sub-category hierarchy (e.g., “Weather—High Winds” or “Public Unrest—Typical Unrest”), allowing the data processing apparatus 20 to assign appropriate risk annotations during the segment-labeling process described above. In some embodiments, a risk-feature-to-label mapping table is maintained in memory 40, enabling traceability and updateability of classification logic as data sources evolve.

In some configurations, the system may optionally incorporate adaptive logic to refine or recommend risk perception profiles based on historical behavior or institutional preferences. For example, if a particular user or organization consistently overrides default tolerances for a given risk type, the system may prompt the user to update their profile or apply learned preferences to future route evaluations. This adaptive behavior may be implemented through lightweight statistical tracking, feedback collection, or, in advanced deployments, machine learning models trained on route selection patterns. These mechanisms allow the system to evolve over time and align more closely with user intent or institutional policy, without requiring manual reconfiguration for each new route.

The road-segment risk data module 44 contains structured associations between road segments and one or more risk labels. Each risk label identifies a type of vulnerability or concern, such as exposure to crime, structural instability, low visibility tunnels, or high-density pedestrian areas. Risk labels may be manually curated, dynamically assigned based on sensor data, or algorithmically inferred from intersecting features within the operating environment. Within the risk data module 44, the risk map layers 46 provide spatial overlays of known or suspected risks. These overlays may include geospatial features from public safety databases, crowd-sourced alerts, or infrastructure data registries, and may be formatted as point-based (e.g., known crime incidents), line-based (e.g., tunnel stretches), or area-based (e.g., weather-impacted zones) features.

The safe haven layers 48 contain spatial representations of support services or protective infrastructure that may influence routing decisions. This may include hospitals, fire stations, police departments, logistics hubs, or command centers, among other examples. These features may be used by the system to compute proximity measures such as travel time to the nearest support facility, identification of coverage gaps along a candidate route, or fallback options in the event of a disruption. In some embodiments, safe haven access zones are defined using graph-theoretic models or travel-time isochrones that account for network topology and dynamic road conditions. In contrast to certain risk features that penalize the desirability of a route, safe haven features may be positively weighted in route evaluation metrics, such that proximity to protective services can increase the suitability score of a route, even if it marginally increases travel time or distance. This enables a nuanced tradeoff between vulnerability avoidance and access to critical infrastructure in sensitive transport scenarios.

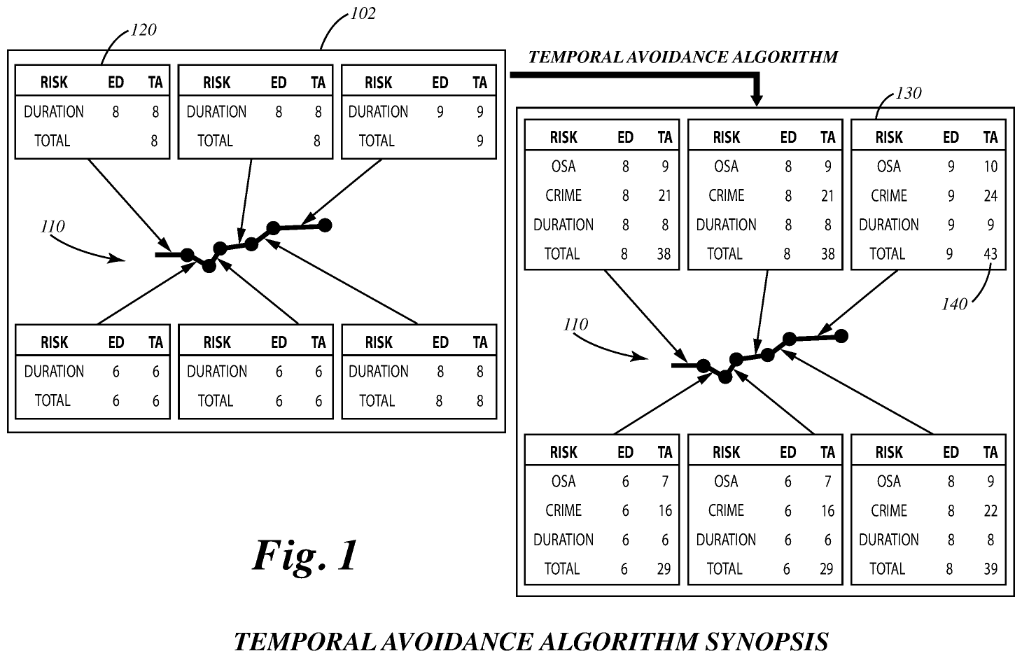

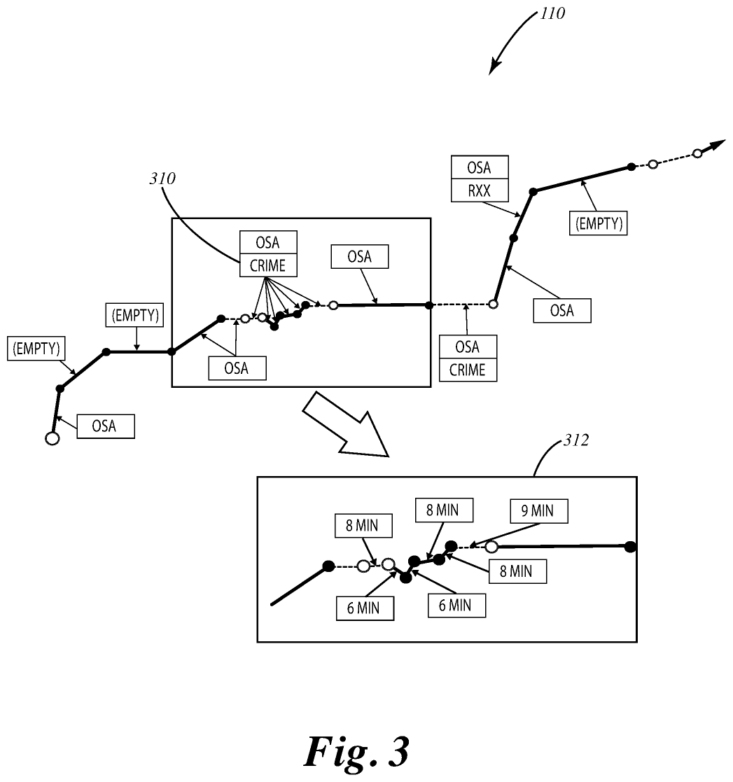

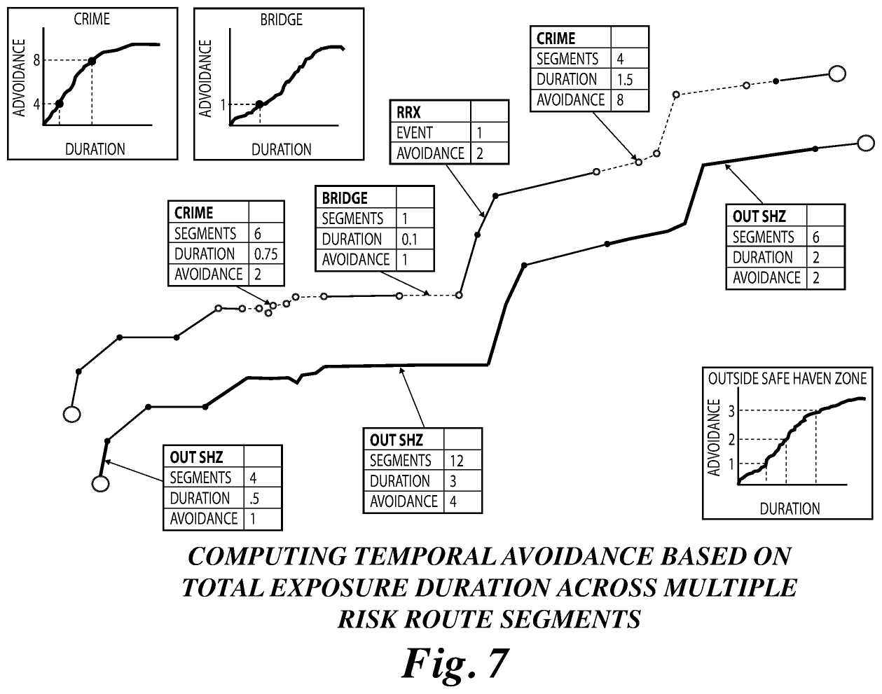

The route data structure 50 organizes route-related information, including road-segment data 52 and segment-level travel durations 54. The road-segment data 52 may include identifiers, coordinate geometries, surface types, traffic characteristics, or metadata indicating the condition or classification of the segment (e.g., arterial, residential, unimproved). Segment-level travel durations 54 may reflect empirical averages, model-based travel estimates, or real-time inputs from connected vehicles or infrastructure systems. These durations serve as the baseline against which risk-aware evaluations are computed. For example, when a road segment is associated with a given risk label, the expected travel duration for that segment may be used to compute an exposure duration (ED), defined as the amount of time a vehicle is expected to remain exposed to a given type of risk while traversing the segment. In some embodiments, segments or connected segment groups are further assigned a temporal avoidance (TA) value, representing the estimated amount of time required to detour around the risk-affected region. These concepts—ED and TA—can enable one way the system can evaluate tradeoffs between risk exposure and route deviation, and are described further with respect to FIGS. 1 and 7. Additionally, segments may be annotated with out-of-service area (OSA) risk labels or indicators, such as absence of cellular coverage, degraded infrastructure, or remoteness from critical services, as discussed further in FIG. 3. These risk-aware annotations and computed metrics are used by the data processing apparatus 20 to score and compare routes in accordance with user-defined tolerances or mission-specific constraints.

FIG. 13 is not intended to limit the architectural arrangement, software configuration, or hardware implementation of the risk routing system 10. The illustrated system architecture represents one exemplary configuration; in other embodiments, individual components may be merged, restructured, or distributed across different computational environments. For example, the data processing apparatus 20 may execute within a remote cloud-hosted service, an edge computing node co-located with a vehicle, or a hybrid configuration that synchronizes across multiple execution environments. Similarly, the memory 40 may include a unified data store or separate modules distributed across networked systems. In some embodiments, portions of the data—such as road-segment risk-perception information or risk-feature map layers—may be loaded dynamically or cached temporarily based on mission requirements or geographic region. The generation of risk-feature maps and exposure duration metrics may occur in real-time, on-demand, or through background preprocessing pipelines. Furthermore, the routing interface 30 may be implemented as a standalone desktop or mobile application, a browser-accessible interface, or an embedded control panel integrated with the vehicle's onboard systems. All such variations, substitutions, and modular implementations are within the scope of the present disclosure.

Referring now to FIG. 1, a temporal avoidance labeling workflow is shown. As illustrated, the system receives, as temporal avoidance input 102, a predefined route 110 comprising a sequence of road segments to be evaluated for context-specific risk. In some embodiments, the route 110 is associated with partially annotated segment metadata 120, which may include segment-level travel durations, exposure durations (ED), and temporal avoidance (TA) values corresponding to one or more risk types. These annotations may have been derived in earlier preprocessing stages based on intersections with risk-feature map layers 46 or may be retrieved from stored memory structures such as route data 50. The data processing apparatus 20 applies a labeling algorithm to evaluate or refine these annotations, determining segment-level risk exposure and assigning or updating values of ED, TA, and associated risk labels. The resulting output is a risk-aware annotated route, with per-segment and cumulative metrics that support comparative evaluation, visualization, and downstream routing decisions. In the current embodiment, the ED, TA, and total values are expressed in units of minutes, but in alternative embodiments these values may be represented in other time units or converted into alternative quantitative representations suitable for the application domain.

In the illustrated example, each segment of the predefined route 110 is annotated with one or more risk labels, an exposure duration (ED), and a corresponding temporal avoidance value (TA). These annotated segments are shown collectively as annotated route segments 130, which together form a risk-enhanced representation of the original route. The data processing apparatus 20 may compute a cumulative temporal avoidance metric 140 by aggregating the TA values across all segments that share a common risk type, exceed a defined threshold, or otherwise satisfy user-defined evaluation logic. For example, if a particular segment has an ED of 8 minutes and a TA of 10 minutes for a given risk, the system may determine that the segment is acceptable, as the exposure falls within the user's configured tolerance, which may be retrieved from the risk perception profile 42. In general, TA values are expected to be greater than or equal to ED values, as they represent the time a user is willing to detour in order to avoid exposure. A segment where ED exceeds TA would be flagged as unacceptable under configured tolerances; and conversely, if TA were less than ED, such an option would likely already be excluded by traditional routing algorithms as it would offer no time or distance benefit. Segments may be retained, flagged, or substituted based on whether the exposure is justified by the detour cost and other mission-specific constraints.

The labeling algorithm may operate by intersecting the temporal avoidance input 102—which includes the predefined route geometry, segment-level travel durations, and relevant metadata—with one or more risk-feature map layers 46 stored in the memory 40. These risk-feature layers may represent spatial encodings of environmental, infrastructural, or operational hazards, including but not limited to degraded bridges, high-crime zones, wildfire perimeters, or tunnel networks. For each road segment in the sequence of route segments, the algorithm evaluates whether it intersects with any such risk features and, if so, identifies the applicable risk labels. Based on the segment's expected travel time, the system then computes an exposure duration (ED) representing the amount of time the vehicle would be exposed to the associated risk type during traversal. This ED value is compared against an appropriate temporal avoidance (TA) value to assess whether the segment meets the configured tolerance for that risk.

In some embodiments, each risk label is associated with a temporal avoidance function, which defines a detour cost in minutes or hours representing the maximum additional time a user or organization would accept to avoid the risk. These functions may be defined globally (e.g., shared across all users), administratively (e.g., configured via institutional policy), or dynamically (e.g., derived from real-time data or user input). For example, a medical transport operation may use a different temporal avoidance function than a convoy operating in a civil unrest zone. The comparison between ED and TA allows the data processing apparatus 20 to evaluate whether a segment should be retained, flagged for substitution, or deprioritized in the final routing output. The resulting annotated segments 130 are available for visual inspection, automated decision-making, or downstream processing stages such as scoring, filtering, or real-time navigation updates. As shown in the right-hand portion of FIG. 1, these annotations may be rendered in a tabular or stacked visual format to facilitate evaluation by planners, analysts, or automated systems.

In addition to risk exposure, the labeling process may incorporate beneficial or mitigating factors—such as proximity to support infrastructure—through integration with safe haven layers 48. When a segment intersects with a known support facility (e.g., hospital, police station, logistics hub), the data processing apparatus 20 may assign a negative temporal avoidance value or apply a positive support score 150, effectively improving that segment's evaluation. This enables the system to balance negative risks with positive resiliencies, such that a segment with minor exposure may still be retained if it ensures proximity to critical services. For instance, a slightly longer route that remains within an emergency medical corridor may be preferred over a marginally faster alternative lacking support access. This dual-scoring mechanism allows the system to evaluate both what should be avoided and what should be favored in accordance with mission objectives and user-defined tolerances.

The temporal avoidance algorithm relies on a structured set of inputs derived from heterogeneous geospatial data sources. These sources can include datasets reflecting both potential risks—such as infrastructural, environmental, or operational vulnerabilities—and beneficial features—such as proximity to safe havens or critical response infrastructure. The preparation of such data may occur as a preprocessing stage prior to the application of route labeling or evaluation logic. In this stage, the system can transform raw geospatial features into structured risk-feature map layers 46, temporal avoidance functions (as stored or referenced by the risk perception profile 42), and annotated predefined routes 110 to form a unified temporal avoidance input 102.

The raw input data may include a wide variety of feature types. For example, point features may include truck stops, ambulance depots, fire stations, or military bases; line features may include tunnels, bridges, railroad crossings, or hazardous slopes; and area features may include floodplains, crime zones, or cellular dead zones. These features may be sourced from third-party datasets, operational sensors, planning tools, or institutional knowledge repositories. Each feature is transformed into one or more risk-feature map layers 46 that encode spatial risk distributions aligned to the road network.

In some embodiments, safe haven features—such as hospitals, police stations, or command centers—are treated not only as informative waypoints but also as indicators of spatial risk when unavailable. That is, when a route moves beyond the effective reach of such infrastructure, the absence of access is itself treated as a contextual risk. To operationalize this, the system performs an “out-of-service-area” (OSA) transformation: safe-haven layers are converted into corresponding OSA risk maps, and these are added to the pool of risk features for evaluation.

Several approaches may be used to define the “in-service” region of a given safe-haven type. In some cases, formal service areas may be defined—for example, jurisdictional response zones for a fire department or emergency medical catchment zones for a hospital. These regions may be directly available from public safety datasets and can serve as first-order approximations of service coverage.

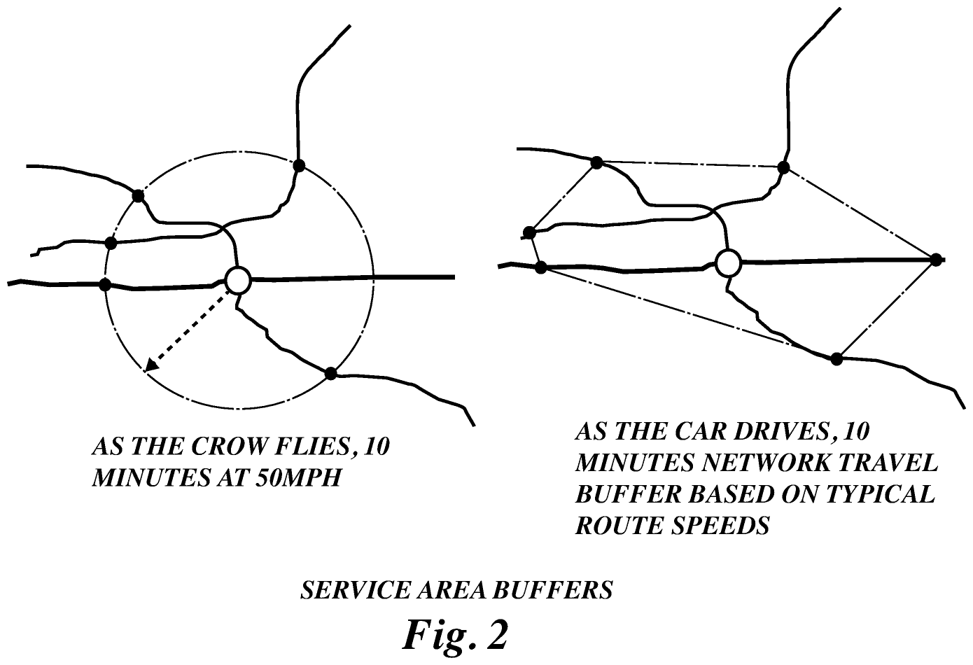

In other embodiments, the system computes effective proximity by generating drive-time or travel-time buffers around each safe haven. For instance, a circular buffer may be created to represent all locations reachable within ten minutes of travel at 50 miles per hour, referred to as the safe haven distance (SHD). Alternatively, a network-aware buffer may be generated using route topology, travel constraints, or estimated driving conditions. FIG. 2 shows an illustrative comparison between these two approaches: a simple circular buffer (left) and a network-based travel-time region (right).

In some embodiments, a hybrid approach may be applied. For instance, formal service areas may be used as a starting point, and an effective proximity constraint may be overlaid to refine or downscale the region based on operational realities. The system may execute a safe haven-to-OSA conversion algorithm that defines each OSA layer as the logical inverse of the union of service areas—i.e., the complement of accessible regions. These generated OSA layers are then included among the risk-feature layers 46 and treated equivalently during route evaluation.

In addition to safe haven transformations, the system supports preparation of general risk features. Risk factor layers may reflect congestion, crime, weather, terrain, infrastructure reliability, or other mission-relevant variables. Each of these may be represented as point, line, or area features depending on the nature of the data. Point features—such as railroad crossings or isolated hazards—may involve spatial buffers to enable proper intersection with route segments. Line features—such as tunnels or bridges—may be aligned to road geometries and annotated directly. Area features—such as storm regions or high-crime zones—may be derived from heat maps or thresholded from continuous metrics to produce binary inclusion zones.

In developing these layers, the system may distinguish between point risks and non-point risks. A point risk is typically associated with a singular encounter (e.g., a bridge or crossing), where exposure duration is effectively zero or negligible. Non-point risks reflect continuous exposure over a span of road segments (e.g., extended congestion or inclement weather). The distinction informs both the exposure duration (ED) calculations and the appropriate buffer or intersection logic for inclusion in segment annotations. Parameters for buffer width, proximity sensitivity, or exposure classification may be user-configurable or set according to policy.

In some embodiments, the service area of a safe haven may be internally represented as a safe haven zone (SHZ), and the corresponding out-of-service region computed as the logical inverse—i.e., OSA=not SHZ. While the term SHZ may not necessarily be exposed to users, it may be used within the system architecture to define and manage service boundaries across different types of protective infrastructure. In this context, time spent outside the SHZ is treated as time spent within an OSA and may be used to compute exposure duration for safe-haven-related risk types. Additionally, the system may apply preprocessing steps such as heatmap thresholding, proximity decay modeling, or jurisdictional filtering when transforming raw data into binary inclusion zones. Parameters controlling buffer widths, inclusion thresholds, or SHD radius may be user-configurable, role-dependent, or governed by institutional policy, allowing the risk-feature preparation process to be tailored to different operational contexts or risk postures.

The temporal avoidance function defines, for each risk type, the maximum detour time a user is willing to accept in order to avoid an identified risk exposure. In general terms, the function represents a user's risk tolerance expressed in minutes or hours—e.g., “I would be willing to drive an extra 25 minutes to avoid a high-crime area with a 10-minute exposure.” In such cases, the system would record a temporal avoidance (TA) of 25 minutes corresponding to that 10-minute exposure duration (ED).

In one implementation, the system assumes a linear relationship between exposure duration and temporal avoidance, such that TA=m×ED, where m is a risk-specific multiplier or weight factor. This linear model simplifies both user interaction and algorithmic implementation. It allows route segment scores to be rapidly recomputed using scalar adjustments and enables intuitive configuration by end users. For example, a user who sets m=2 for a given risk type indicates that they would tolerate a detour of up to twice the exposure duration to avoid that risk.

The value of m may be elicited through a structured user interface or predefined in policy. For instance, a slider element may allow the user to experiment with different multipliers within a defined range. At one end of the slider, avoidance behavior may be negligible (m˜0), while at the other end, the user may express a highly risk-averse posture (e.g., m≥3). In some embodiments, the interface may allow the user to set both a minimum and maximum detour value for each risk type, defining a bounded linear or piecewise function. As the user adjusts the slider or control input, the system may immediately recalculate segment scores and update the visual representation of route preferences.

For non-point risks—such as congestion zones or crime areas—the TA function may be applied continuously across segments that intersect with the risk. For point-based risks—such as a railroad crossing or tunnel entrance—there may be no meaningful ED to compute. In such cases, the TA function may be defined independently. For example, the user may be prompted to answer, “What is the maximum detour time you would accept to avoid this type of hazard?” The resulting TA value can be directly applied to any segment intersecting the corresponding point risk.

This distinction between continuous and event-based risks enables the system to apply consistent yet flexible evaluation logic. For temporal avoidance embodiments, the TA values are integrated into the broader risk perception profile 42 and used by the data processing apparatus 20 to compare route options. If a segment's computed ED exceeds the corresponding TA for any risk type, the system may flag the segment for avoidance or substitution. Conversely, segments falling within the acceptable tolerance window may be preferred or weighted more favorably during scoring.

To annotate the predefined route 110 with risk-specific attributes, the system intersects the route's constituent segments against each risk-feature map layer 46. This intersection process supports assignment of temporal avoidance metrics by determining which segments are impacted by which risk types and to what extent. For each intersected feature, the system identifies: (i) the applicable risk label, (ii) the estimated exposure duration (ED), and (iii) the corresponding temporal avoidance (TA). These values are then stored as part of the annotated segment structure 130.

Because individual route segments may cross multiple risk-feature layers, the system treats the segment-to-risk relationship as a many-to-one mapping. In some environments, multiple overlapping risks—such as degraded infrastructure, environmental hazards, or service outages—may affect the same region. In these cases, intersections between risk features and route segments may be partial rather than complete, requiring additional processing to ensure that each segment is accurately annotated with applicable risk labels and corresponding metadata.

For point-based risks (e.g., a tunnel entrance or railroad crossing), the entire route segment that includes the point is typically annotated without additional modification, as the risk is treated as a singular event rather than a duration-based exposure. However, for non-point risks (e.g., high-crime zones or extended construction), which may partially overlay route segments, the system may optionally split segments at feature boundaries. This ensures that each resulting segment falls entirely within or entirely outside the risk region, allowing precise attribution of ED and TA values.

To distinguish original segments from those modified during intersection, the system creates a new set of “risk road segments,” derived by segmenting the original route wherever a risk-feature intersection occurs. In one implementation, the data processing apparatus 20 iterates over each risk-feature layer and applies the following logic.

For each area-based risk feature, the system checks whether any route segment intersects the feature geometry. If an intersection is detected, the system determines whether the segment is fully or partially contained within the feature. Fully contained segments are labeled directly; partially intersecting segments may be split to ensure accurate exposure accounting

For line-based features (e.g., tunnels or narrow bridges), the system again tests for intersection. If the route segment overlaps the line feature, it is labeled with the corresponding risk type. Segment splitting may occur if partial overlap is detected, and policy settings require duration-sensitive tagging.

For point-based features, no splitting occurs. Instead, if a segment includes the point location, the entire segment is annotated with the associated risk label. Because point risks do not require exposure-duration modeling, they are treated as instantaneous encounters and annotated accordingly.

Although the logic may be implemented in various ways, one illustrative approach is summarized below in plain-language format for clarity and completeness. This example outlines the segment-splitting logic as executed by the system in response to geographic intersections with risk-feature map layers:
Initialize a working list of route segments as original segments.
For each risk-feature layer:
   Iterate through each feature in the layer.
   If the feature is an area:
      Determine if any segments intersect with the area.
      For intersecting segments, split at boundary edges as necessary to ensure that each resulting segment is fully contained within or outside the area.
      Assign the applicable risk label(s) and create corresponding risk road segments.
   If the feature is a line:
      Detect whether any segments intersect with the line.
      For intersecting segments, assign the risk label; in some embodiments, the segment may be split if only a partial overlap occurs.
   If the feature is a point:
      Identify the segment in which the point falls.
      Assign the point-based risk label to the entire segment without splitting.

This process ensures that each resulting risk road segment is associated with clearly defined spatial and risk attributes. Although the segmentation may increase the number of route segments temporarily, it allows the system to maintain fidelity in risk attribution and supports precise computation of cumulative exposure metrics. The newly labeled segments 130 can then be used to compute updated totals (e.g., cumulative TA or ED by risk type), which in turn support downstream decision making, visualization, and instruction generation.

As the system processes multiple risk-feature layers, the working list of segments may be iteratively refined. That is, route segments may be split multiple times as they intersect with different risk types across successive layers. To support this, the data processing apparatus 20 can maintain a working segment set that is updated after each layer is applied. The underlying geometry and segment lineage may be preserved throughout this process, enabling traceability back to the original route geometry 110 and facilitating re-aggregation or explanation logic. This iterative splitting process ensures that each resulting risk road segment is unambiguously associated with the risk label(s) relevant to its precise geographic span—thereby enabling accurate exposure duration (ED) computation and risk-specific temporal avoidance (TA) assignment in downstream processing.

Referring now to FIGS. 3 through 6, a series of diagrams is shown illustrating how the system computes exposure duration (ED) and temporal avoidance (TA) values for individual risk road segments 130, based on the risk labels assigned during the segment-splitting and labeling process described above.

For each annotated segment within the risk road segment set, the data processing apparatus 20 determines the applicable exposure duration and computes a corresponding temporal avoidance value based on the user-defined or policy-defined temporal avoidance function for the relevant risk type. FIG. 3 illustrates a representative predefined route 110 containing a mix of segment annotations, including segments labeled with crime, rail road crossings (RXX), and out-of-service area (OSA) risks.

As shown in the zoomed-in portion of inset view 312 of FIG. 3, multiple contiguous segments may be labeled with the same risk type (e.g., “crime”), forming what is referred to herein as a risk event 310. In the example illustrated, six contiguous segments are labeled with a “crime” risk and include individual segment-level travel durations ranging from 6 to 9 minutes. The system aggregates these values to compute a total exposure duration of 45 minutes for the risk event.

The aggregated exposure duration is then used as the input to the temporal avoidance function defined for the corresponding risk type. For instance, if the crime-related TA function is configured with a linear multiplier of 2×, the resulting TA for the entire risk event would be 90 minutes. This value represents the maximum detour time the user or system would be willing to incur to avoid the cumulative 45-minute exposure.

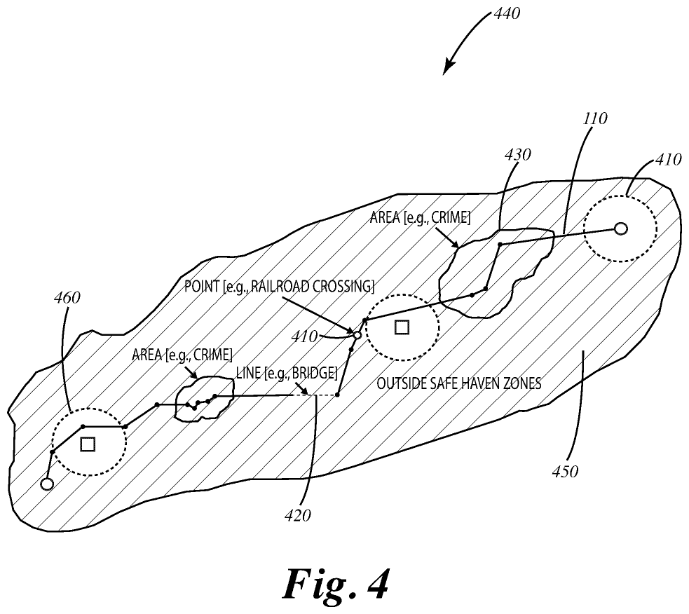

As shown in FIG. 4, different types of risk features may overlap or coexist along a route. In the illustrated embodiment, a point-based risk 410 (e.g., a railroad crossing), a line-based risk 420 (e.g., a bridge), and an area-based risk zone 430 (e.g., a high-crime neighborhood) are each represented along the predefined route 110. The map layer 440 containing these features may correspond to a particular risk-feature map layer 46 in memory 40, such as a crime, infrastructure, or service-access dataset.

Also shown in FIG. 4 is a shaded outer region representing an out-of-service area 450, which corresponds to the result of the OSA transformation process described above. This OSA region reflects areas beyond the effective reach of one or more safe haven types, such as hospitals or emergency responders. Segments falling within the OSA region may be annotated accordingly, and those intersecting multiple risk types—including both explicit and contextual risks—may be assigned compound labels or evaluated under multi-factor TA functions. The illustration emphasizes how the system supports both simultaneous and layered risk representation using geospatial overlays.

In the illustrated embodiment of FIG. 4, each safe haven service area 460 is depicted as a dotted circular region indicating geographic zones that fall within an acceptable proximity threshold to a designated support facility (e.g., a hospital or fire station). These zones may be generated using fixed-radius buffers, travel-time isochrones, or formal jurisdictional boundaries. As described above, the union of all such safe-haven service areas 460 defines the accessible region, while the complement—shown as the shaded region labeled OSA region 450—represents the out-of-service area. The system may use these delineations to determine whether any portion of a given route segment lies outside the bounds of available support infrastructure and, if so, assign an OSA risk label with corresponding exposure and avoidance metrics.

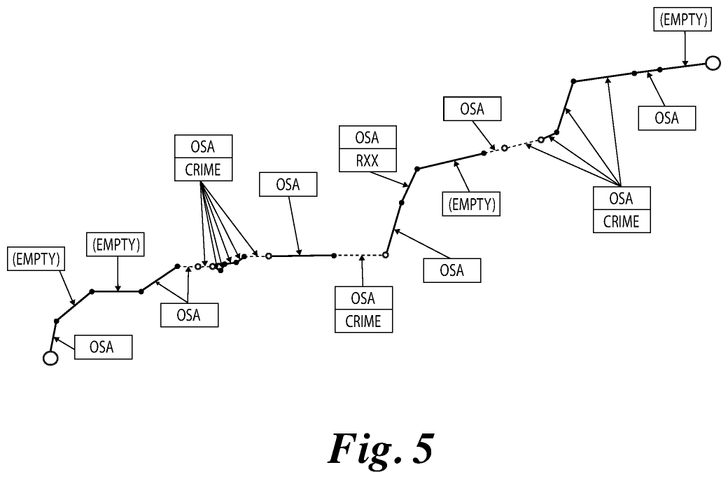

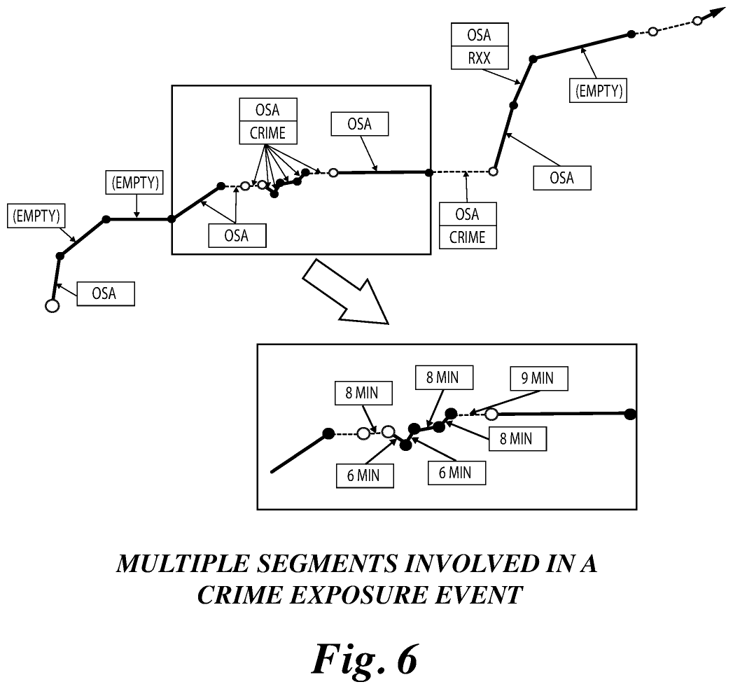

In some embodiments, risk events may span multiple road segments that are not interrupted by other risk types. For each such risk event, the system first identifies the continuous set of segments sharing the same risk label and calculates the total exposure duration. The calculated TA value for the event is then disaggregated proportionally across each contributing segment based on that segment's individual travel time. This is shown in greater detail in FIG. 5 and the inset view of FIG. 6, where each segment is annotated with both its individual travel time and its share of the total temporal avoidance value. In these examples, the segments may be retained, flagged, or replaced depending on user-configured tolerances. While FIGS. 5 and 6 illustrate segment-level breakdowns using a single path for clarity, the temporal avoidance values reflected may ultimately be used to evaluate alternatives or justify deviations from the illustrated route.

For example, if the temporal avoidance for the full event is 2 hours and one contributing segment accounts for 20% of the exposure duration, then that segment is annotated with a TA of 24 minutes. This proportional attribution enables precise downstream scoring and allows mission planners or automated evaluators to isolate and assess individual segments based on the relative risk penalty they contribute to the overall route. In some embodiments, this disaggregated view may also inform selective rerouting, segment prioritization, or cumulative scoring logic applied at the route level.

For point-based features that do not have duration-based exposure (e.g., railroad crossings or entry points to tunnels), the TA value may be applied directly without aggregation or disaggregation. As shown in FIG. 4, the risk label is assigned to the entire segment that contains the point, and the temporal avoidance function for the corresponding risk type determines the appropriate TA value for that segment. This ensures that even instantaneous or localized hazards are represented in the overall risk profile.

This exposure-duration-driven evaluation enables the system to compute risk-adjusted metrics for each segment and for the route as a whole. These metrics support route comparison, rerouting decisions, and risk communication through the user interface 30. In some embodiments, annotated segments—each carrying one or more risk labels, exposure durations (ED), and temporal avoidance values (TA)—may be visualized using color-coded overlays or symbol markers. The user may filter, flag, or prioritize segments in accordance with threshold criteria specified in the risk perception profile 42 or with externally defined mission policies. These visualizations enable planners and operators to assess not only route efficiency, but the qualitative and quantitative tradeoffs inherent in different routing decisions.

In the final step of the temporal avoidance labeling process, the system computes temporal avoidance metrics at the level of the original route segments 110. These original segments may have been subdivided earlier into smaller “risk road segments” 130 during the risk-feature intersection process described above. Each of those child segments carries exposure duration (ED) and temporal avoidance (TA) values for one or more associated risk types.

The system aggregates this metadata upward, enabling the parent segment to inherit cumulative or representative values for each relevant risk type. For example, if a particular original segment was split into three child segments—each with different but overlapping risk labels—the system may compute total ED and TA values for the parent segment by summing, averaging, or otherwise fusing the values of its constituent children. FIG. 7 illustrates this process by showing multiple risk events that span across subsegments and the corresponding temporal avoidance values calculated from their aggregated exposure durations.

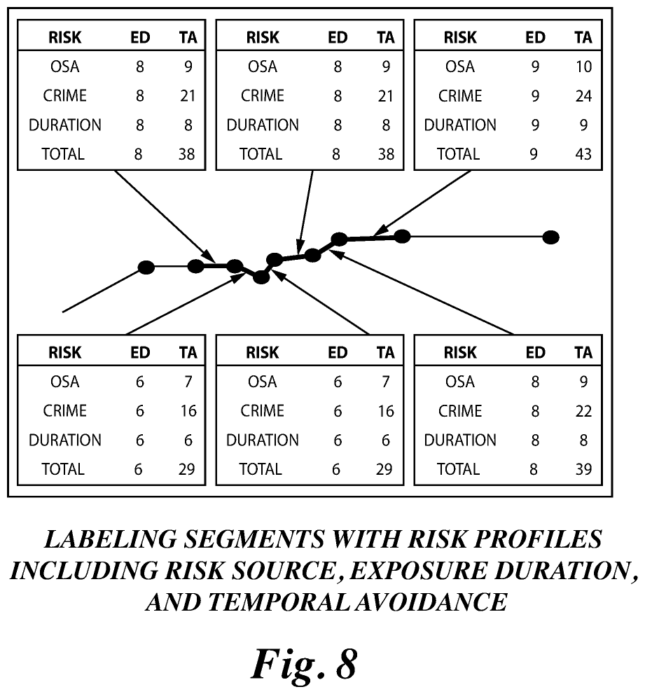

As shown in FIG. 8, the final route representation may annotate each original road segment with a multi-risk profile that includes:
the set of risk types associated with that segment,
the cumulative or average exposure duration (ED) for each risk type, and
the computed or inherited temporal avoidance (TA) value for each risk type.

These metrics are presented alongside each segment in a tabular format to support comparison, visualization, or downstream decision-making. Depending on the configuration, the system may also include per-segment totals or composite route-level summaries, which reflect how different risks aggregate across the full route.

In some embodiments, these inherited values may be dynamic and time dependent. For example, the exposure associated with a congestion risk label might vary by time of day. The system may retrieve or infer time-dependent travel durations d (t) for the affected segments and recompute ED and TA values accordingly. In this way, route evaluation remains sensitive to real-world variability and supports time-aware routing scenarios.

In some embodiments, the system includes a user-facing interface that enables visualization, configuration, and interaction with temporal avoidance parameters and risk-aware route evaluations. This interface may be implemented via a web-based dashboard, vehicle-mounted display, or command center terminal, and is designed to allow users to explore risk exposures, adjust avoidance tolerances, and observe the effects of these changes on candidate routes in real time.

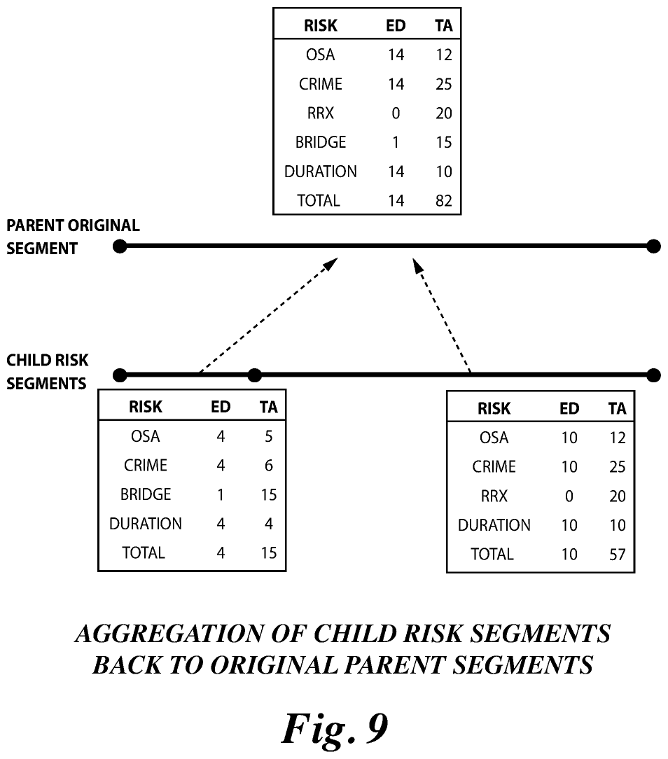

Before user interaction, the system may execute a backend operation that aggregates risk annotations from risk road segments back to their corresponding original route segments. As described above with respect to segment splitting, a single original segment may be divided into multiple risk road segments based on intersections with risk-feature map layers 46. In this final step of the annotation pipeline, the data processing apparatus 20 recomputes each original segment's risk profile by aggregating the labels, exposure durations (ED), and temporal avoidance values (TA) of its associated children. This is illustrated in FIG. 9, where each original segment (parent) inherits risk data from a set of split segments (children). The result is a complete set of annotated route segments that preserve alignment with the original path while incorporating detailed risk-aware metrics.

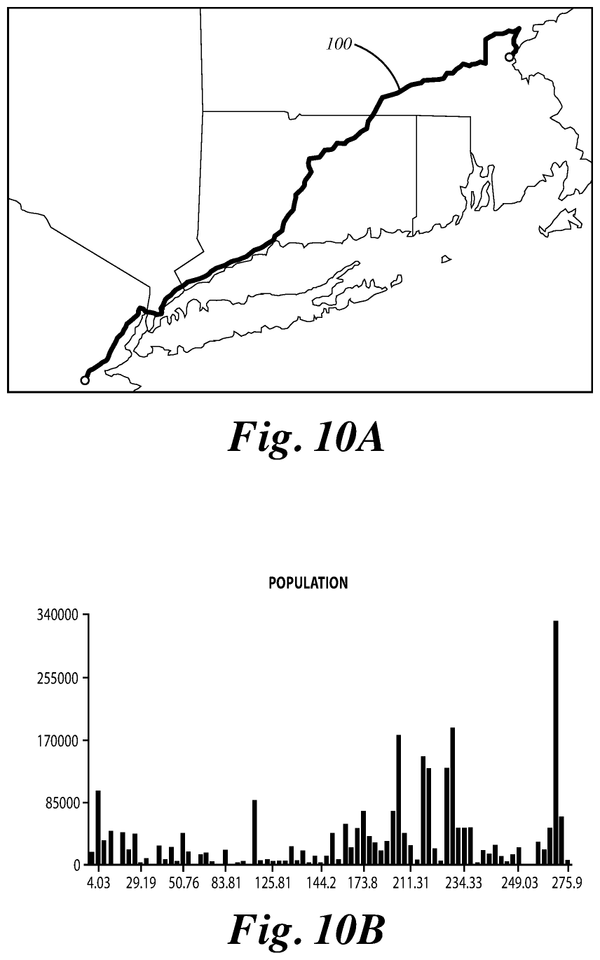

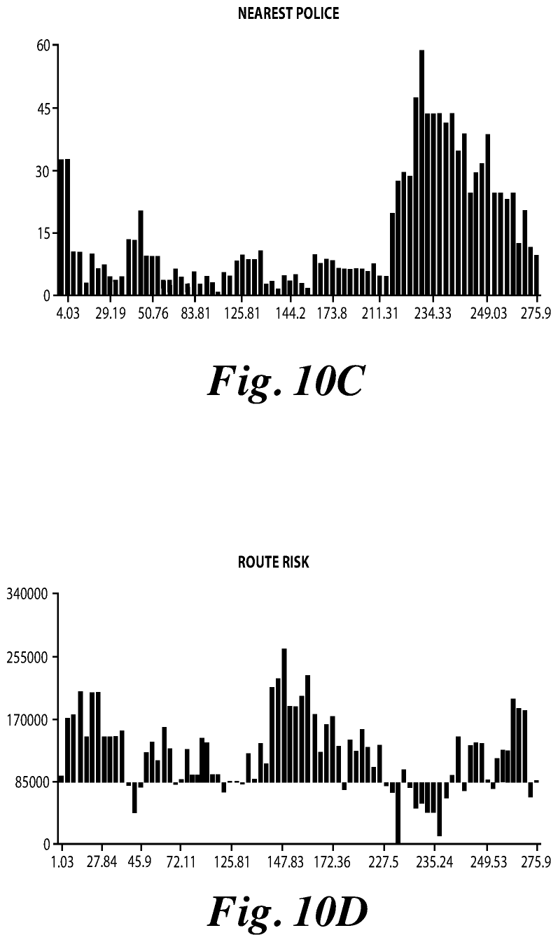

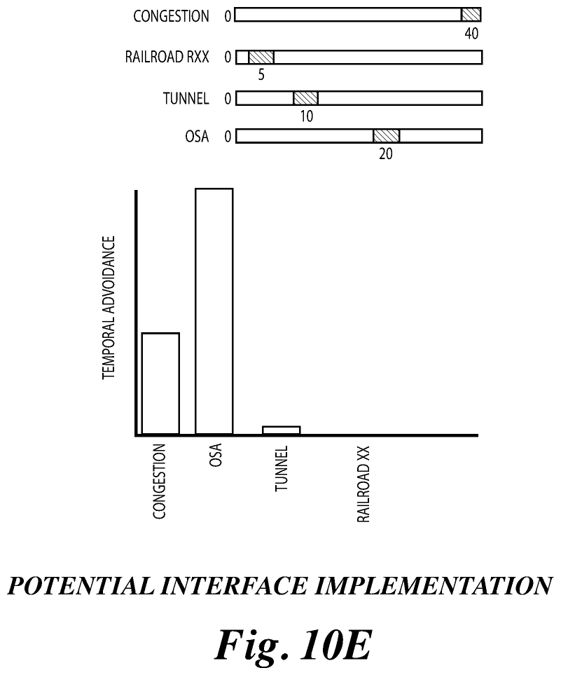

The interface may then present this annotated route to the user in the form of an interactive geographic visualization, enabling inspection and comparison of individual segment profiles and cumulative route metrics. As shown in FIG. 10A, the system displays the predefined route 110 overlaid on a geographic map, which may be rendered using street-level detail, satellite imagery, or stylized routing views depending on configuration. Each segment of the route may be color-coded according to risk score, exposure duration (ED), or temporal avoidance (TA), with dynamic gradients or discrete color bands representing severity or criticality across different risk types.

In some embodiments, the interface supports interactive exploration of segment-level annotations through context-appropriate UI elements tailored to the deployment environment. For desktop or planning terminals, this may include clickable or hoverable route segments that reveal tooltips or pop-up panels summarizing annotations such as risk labels, exposure durations (ED), avoidance values (TA), and explanatory metadata or source provenance.

In vehicle-mounted or touch-based systems, the interface may instead present selectable segments via touch gestures, voice queries, or a scrolling sidebar that lists segment details in sequence with the map view. Upon selection, the corresponding segment may be visually highlighted on the route map, and a summary card may appear showing associated risks and scores. Alternatively, the system may cycle through segment information automatically as the vehicle progresses along the route, displaying risk alerts or annotation summaries on a heads-up display or secondary screen without requiring user input.

Symbolic markers or icons may be placed directly on the route map to indicate specific risks—such as tunnels, bridges, grey/black swan events, or congestion zones—and may be accompanied by visual overlays for safe haven proximity, out-of-service area boundaries, or high-risk clusters. These interface elements provide drivers or operators with at-a-glance awareness of upcoming risks and support passive situational monitoring during travel.

In real-time or planning modes, the route visualization may update dynamically in response to user input—e.g., adjusting the user's risk tolerance threshold may cause the route to reconfigure, substitute segments, or reroute around newly disfavored regions. The interface may provide animated transitions, flashing indicators, or route comparison overlays to help users perceive how their risk posture affects route selection. In some embodiments, alternate route options may be displayed in parallel with the current route, allowing the user to toggle between options and view relative metrics such as travel time, risk exposure, and safe haven access. These visualizations collectively support intuitive, risk-aware decision-making by bridging abstract risk metrics with concrete spatial representations of route alternatives.

In addition to geographic visualization, the system may present contextual data aligned to the route. For instance, FIG. 10B illustrates a population distribution graph, with population values plotted as a function of position along the route. FIG. 10C similarly shows the proximity to law enforcement or emergency services at each point along the route, helping users identify support-access gaps.

FIG. 10D provides an aggregated risk profile for the route, allowing users to visualize how cumulative exposure varies along its length. This risk profile may be derived from segment-level TA values or computed from a combination of ED, TA, and contextual risk scores.

To enable real-time control over routing behavior, the interface may expose a set of sliders or control elements, as illustrated in FIG. 10E. These allow the user to adjust the temporal avoidance tolerance associated with each risk type (e.g., congestion, railroad crossings, tunnels, or out-of-service areas). The system may impose minimum and maximum bounds and may also provide visual feedback—such as bar charts—depicting the current avoidance configuration across all active risk types.

As users adjust these controls, the data processing apparatus 20 dynamically updates the temporal avoidance input 102, recomputes segment scores, and refreshes the annotated map or route evaluation results. This interactivity allows mission planners or operational users to simulate changes in risk posture, explore alternate routing strategies, or test the impact of more or less conservative avoidance thresholds.

While the illustrative embodiment is GUI-based, the interface logic may also support programmatic access via APIs, voice-driven configuration, or automated policy templates that adjust avoidance values based on mission type or operational directives. In all cases, the interface serves as the operational bridge between structured risk representation and real-world route decision-making.

In a second embodiment, the system enables user-configurable routing behavior by allowing users to define or adjust risk perception profiles via an interactive interface. This capability permits risk tolerances to be specified in a structured and scalable manner, allowing risk sensitivity to be modulated per risk type based on the user's preferences, operational constraints, or institutional guidance. The resulting configurations are used by the data processing apparatus 20 to generate or update route recommendations and temporal avoidance thresholds.

As shown in FIG. 11, the system may present a graphical control element 500 in the form of a Likert-style slider associated with a particular risk type—such as bridges, tunnels, or degraded infrastructure. The slider spans an ordinal range (e.g., 1 to 10) and is divided into labeled zones indicating escalating levels of perceived risk severity: for example, “Acceptable,” “Undesirable,” “Highly Undesirable,” and “No-Go.” A pointer 510 is placed along the slider to represent the user's currently selected threshold. In some embodiments, a hashed or shaded region 512 is displayed on the slider to represent a statistical range of peer-defined or historically derived settings for the corresponding risk type. Together, the pointer 510 and statistical range 512 allow users to contextualize their own tolerance levels relative to broader norms or mission defaults. The pointer position is used by the data processing apparatus 20 to evaluate whether annotated segments 130 satisfy the user-defined threshold or require adjustment.

In some embodiments, the statistical range 512 is derived from aggregated tolerance values submitted by prior users, expert groups, or policy templates, and may be represented as an interquartile band corresponding to the middle 50% of recorded values. This allows users to gauge how their selected pointer position compares to the normative distribution of acceptable thresholds for the same risk type. For instance, placing the pointer 510 above the upper quartile may signal a more conservative risk posture, prompting the system to treat certain segments as unacceptable and trigger rerouting. Conversely, a pointer within the interquartile range may be interpreted as consistent with baseline expectations, while a value below the lower quartile may indicate greater tolerance or mission-driven flexibility. This comparative framing supports decision-making by showing not only the user's chosen threshold but how it aligns—or deviates—from established risk norms.

In some embodiments, these sliders may be dynamically responsive. That is, adjusting the pointer for a given risk type will immediately trigger recalculation of annotated route segments 130, updated exposure durations (ED), and corresponding temporal avoidance (TA) values. This interactive feedback loop enables users to visualize how increasing or decreasing sensitivity to a risk category affects the routing solution space. Default slider values may be pre-populated using historical data, mission templates, or inferred from aggregated user feedback.

The slider 500 operates as a live control element within the user interface 30. As the pointer 510 is moved along the ordinal scale, the system dynamically updates routing logic to include or exclude segments based on the newly applied threshold. Segments with ordinal risk values exceeding the threshold may be marked as unacceptable and filtered from candidate route options. The data processing apparatus 20 recalculates affected exposure durations and temporal avoidance values, updating annotated segment displays in real time. In this manner, the slider serves not only as a preference-setting tool but also as an operational threshold selector with immediate algorithmic effect.

The system architecture is designed to support real-time responsiveness to dynamic risk conditions while preserving the integrity of predefined user or institutional tolerances. That is, while the underlying risk environment may evolve rapidly—for example, due to emergent civil unrest, road closures, or extreme weather events—the user-configured perception thresholds and avoidance preferences can remain fixed during operation unless explicitly redefined. This separation allows route updates and rerouting behavior to be driven automatically in accordance with prior risk posture selections, without requiring users to manually intervene or adjust settings in the midst of unfolding events. In this way, the system ensures that routing decisions remain consistent with the user's original intent, even when new data is ingested, or risk annotations are updated in real time.

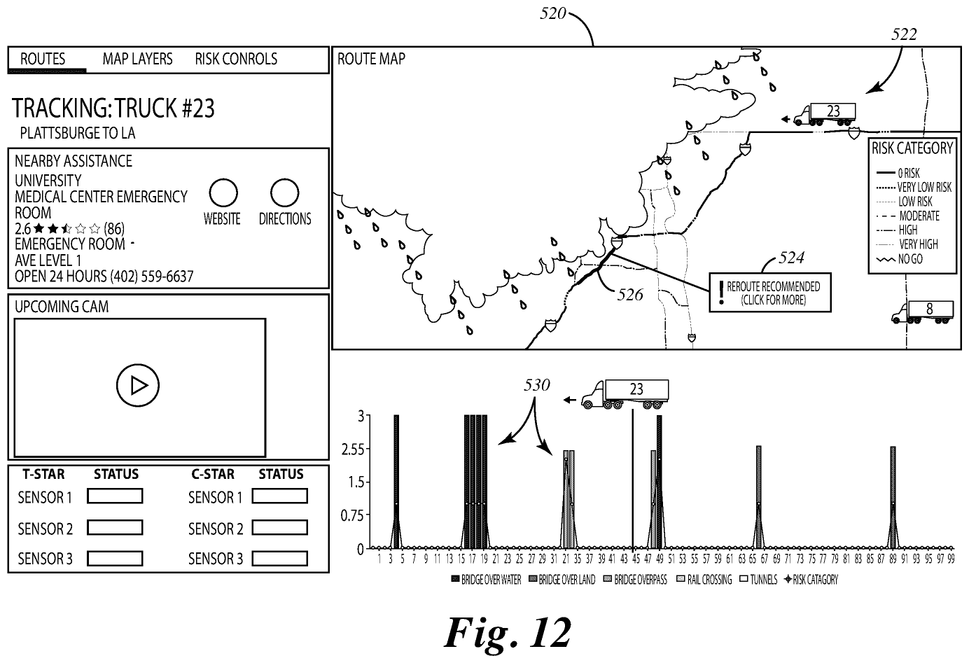

FIG. 12 illustrates an alternative user interface implementation that integrates the described risk perception inputs with real-time mapping and convoy tracking capabilities. The map pane 520 displays a route map with one or more vehicle positions indicated along the route. A map legend corresponds to the different levels of risk along the route as determined by peer review. Below the map or adjacent to the route axis, the interface includes a visual strip or bar that tracks the sequence of route segments and visually indicates the upcoming risks. Distributed along this strip are a series of vertically oriented markers 530, each visually representing a risk feature aligned to a specific segment or location on the route. These markers may indicate risk types such as bridge crossings, tunnels, railroad intersections, or other categorized risks. In some embodiments, these visual indicators vary in shape or iconography to denote risk category or severity, enabling quick at-a-glance assessment by the user. The arrangement conveys both the location and relative frequency of encountered risks along the route, supporting real-time decision-making. In some embodiments, the displayed risk levels may reflect aggregated peer evaluations or institutionally defined risk perception profiles, visually correlating route segments with prevailing risk posture norms.

In the illustrated interface of FIG. 12, the left-hand region displays supplemental mission-relevant data, including convoy status indicators (e.g., “Truck #23”) and proximity to nearby assistance resources such as hospitals or emergency response facilities. Additional indicators may represent live sensor telemetry—such as vehicle system health, threat detection status, or environmental conditions—which can be surfaced via iconographic alerts or real-time data feeds. In some embodiments, this panel may also include metadata describing route assumptions, operational constraints, or user role context, supporting traceability and auditability of routing decisions.

The integration of vehicle telemetry and contextual awareness allows the system to dynamically adapt the risk perception profile 42 or trigger scenario-specific routing behavior. For example, if onboard systems detect heightened threat levels or degraded vehicle performance, the user interface 30 may prompt the operator to update their selected tolerance posture or activate a predefined conservative routing configuration. These interactions support the second embodiment's risk-perception alignment by enabling routing behavior to be informed not only by static thresholds, but by dynamic conditions and evolving mission priorities.

As shown in FIG. 12, the user interface may also support live alerts and rerouting prompts in response to newly detected or evolving risks. For instance, in the illustrated embodiment, a reroute recommended notification 524 associated with an affected portion 526 of the route is displayed on the map pane when the system identifies that a weather event is projected to intersect the current route. This popup may be generated based on live data feeds and evaluated against the user's pre-configured risk tolerances. In some embodiments, the popup includes a summary of the triggering risk (e.g., type, severity, expected arrival time), along with options for the user to accept an alternate route, view affected segments, or suppress the alert. This interface feature demonstrates the system's ability to dynamically monitor situational conditions and respond by prompting route updates consistent with the user's mission profile and risk posture.

In this embodiment, the interface is not merely for visualization but becomes an operational decision-support tool. It consolidates static spatial risk features, dynamic convoy attributes, and interactive risk preference settings into a cohesive platform. This allows for real-time adjustment and personalization of routing logic, which can be particularly valuable in mission-critical or high-uncertainty scenarios.

In some versions of the system, the user interface 30 may additionally support group-based decision making. For example, risk tolerances from multiple stakeholders—such as shippers, operators, and regulators—may be reconciled into a composite risk perception profile using a Delphi-style elicitation process or consensus mechanism. These values can then be locked, weighted, or selectively overridden depending on the system's configuration and operational constraints.

The interface architecture represented across FIGS. 11 and 12 illustrates complementary views: the control interface of FIG. 11 enables user-defined threshold adjustment using ordinal sliders, while the dashboard of FIG. 12 visualizes the resulting route selections and risk overlays. Together, they form an exemplary user-centric feedback loop in which risk perceptions can be configured in structured form and immediately reflected in operational routing outputs. This modularity allows users to maintain a high-level overview while retaining granular control over individual risk tolerances.

The foregoing description illustrates a flexible and extensible system for risk-informed route planning using structured perception data, spatial risk mapping, and user-configurable evaluation logic. While various embodiments have been described—including those relying on temporal avoidance values and those incorporating ordinal preference scales—the underlying principles may be adapted to a wide range of routing systems, mission profiles, and operational environments. The disclosed system is not limited to a particular type of risk, user interface, or deployment context; instead, it provides a modular architecture in which different types of risk perception inputs, scoring functions, and visualization strategies can be integrated and tailored based on evolving requirements.

In various implementations, the risk-aware routing system may be used in centralized planning centers, embedded vehicle systems, mobile devices, or web-based interfaces, and may interoperate with third-party data sources, geospatial tools, or command-and-control platforms. Routing recommendations may be presented visually, transmitted to downstream systems, or used to generate audit logs, compliance artifacts, or training datasets. The architecture is designed to support real-time adjustments, user-driven override logic, and extensible risk taxonomies, allowing the system to evolve in response to new threats, stakeholder priorities, or operational guidance.

Although the present disclosure provides specific examples, figures, and reference numerals to aid understanding, these are not intended to limit the scope of the invention. The components, processes, and data structures described herein may be rearranged, combined, substituted, or omitted in various configurations while still falling within the scope of the claims. All such modifications, extensions, or functional equivalents are considered to be within the spirit and scope of the invention as described.

Directional terms, such as “vertical,” “horizontal,” “top,” “bottom,” “upper,” “lower,” “inner,” “inwardly,” “outer” and “outwardly,” are used to assist in describing the invention based on the orientation of the embodiments shown in the illustrations. The use of directional terms should not be interpreted to limit the invention to any specific orientation(s).

In addition, when a component, part or layer is referred to as being “joined with,” “on,” “engaged with,” “adhered to,” “secured to,” or “coupled to” another component, part or layer, it may be directly joined with, on, engaged with, adhered to, secured to, or coupled to the other component, part or layer, or any number of intervening components, parts or layers may be present. In contrast, when an element is referred to as being “directly joined with,” “directly on,” “directly engaged with,” “directly adhered to,” “directly secured to,” or “directly coupled to” another element or layer, there may be no intervening elements or layers present. Other words used to describe the relationship between components, layers and parts should be interpreted in a like manner, such as “adjacent” versus “directly adjacent” and similar words. As used herein, the term “and/or” includes any and all combinations of one or more of the associated listed items.

The above description is that of current embodiments of the invention. Various alterations and changes can be made without departing from the broader aspects of the invention as defined in the appended claims, which are to be interpreted in accordance with the principles of patent law including the doctrine of equivalents. This disclosure is presented for illustrative purposes and should not be interpreted as an exhaustive description of all embodiments of the invention or to limit the scope of the claims to the specific elements illustrated or described in connection with these embodiments. For example, and without limitation, any individual element(s) of the described invention may be replaced by alternative elements that provide substantially similar functionality or otherwise provide adequate operation. This includes, for example, presently known alternative elements, such as those that might be currently known to one skilled in the art, and alternative elements that may be developed in the future, such as those that one skilled in the art might, upon development, recognize as an alternative. Further, the disclosed embodiments include a plurality of features that are described in concert and that might cooperatively provide a collection of benefits. The present invention is not limited to only those embodiments that include all of these features or that provide all of the stated benefits, except to the extent otherwise expressly set forth in the issued claims. Any reference to claim elements in the singular, for example, using the articles “a,” “an,” “the” or “said,” is not to be construed as limiting the element to the singular. Any reference to claim elements as “at least one of X, Y and Z” is meant to include any one of X, Y or Z individually, any combination of X, Y and Z, for example, X, Y, Z; X, Y; X, Z; Y, Z, and/or any other possible combination together or alone of those elements, noting that the same is open ended and can include other elements.

Reference throughout this specification to “a current embodiment” or “an embodiment” or “alternative embodiment” means that a particular feature, structure, or characteristic described in connection with the embodiment is included in at least one embodiment herein. Accordingly, the appearance of the phrases “in one embodiment” or “in an embodiment” or “in an alternative embodiment” in various places throughout this specification are not necessarily all referring to the same embodiment. Furthermore, the particular features, structures, or characteristics may be combined in any suitable manner with or in one or more embodiments.

What is claimed is:

1. A system for managing road transportation of sensitive materials through a geographic, the system comprising:
a memory configured to store road-segment risk-perception information that includes, for each of a plurality of road segments of the geographic region, one or more risk labels identifying respective types of risk to which the sensitive materials would be exposed while being transported over the road segment,
a routing interface configured to receive, from a user, a request for information related to a route along which a vehicle is to transport the sensitive materials, wherein the route includes a plurality of the road segments of the geographic region, and wherein at least some of the road segments are individually avoidable by exiting the route at one end of the road segment and rejoining the route at the other end after traveling along one or more off-route roads; and
a data processing apparatus communicatively coupled with the memory and the routing interface, the data processing apparatus configured to:
access the route-related request from the routing interface,
retrieve, from the memory, a portion of the road-segment risk-perception information associated with the plurality of the road segments of the route,
generate, based on the retrieved portion, an instruction for operating the vehicle to transport the sensitive materials along the route, and
output, to the routing interface, the generated instruction to be used by the vehicle operator.

2. The system of claim 1, wherein the road-segment risk-perception information includes, for each risk label associated with a given road segment:
a corresponding exposure duration representing an expected amount of time during which the sensitive materials would be exposed to a risk of that type while being transported over the road segment; and
a corresponding avoidance duration representing an estimated amount of time to traverse one or more alternative road segments in order to avoid the risk of that type for the given road segment;
wherein the data processing apparatus is configured to generate the instruction by comparing, for at least some of the road segments of the route, the corresponding exposure duration and avoidance duration.

3. The system of claim 1, wherein the road-segment risk-perception information includes, for each risk label associated with a given road segment:
an ordinal value on an acceptability scale, the ordinal value representing a degree of perceived risk associated with the risk label relative to other risk labels;
and wherein the data processing apparatus is configured to generate the instruction by comparing at least some of the ordinal values to one or more thresholds associated with route selection criteria.

4. The system of claim 3, wherein each ordinal value is associated with a statistical range derived from multiple evaluations of perceived risk for a given risk label, and wherein the statistical range characterizes the range of perceived risk associated with the road segment and is provided, via the routing interface, for display to a user.

5. The system of claim 4, wherein the routing interface is configured to display the statistical range associated with each risk label to facilitate user selection of a personalized threshold value on the acceptability scale, wherein the statistical range reflects variation in perceived risk collected from multiple sources, and wherein the data processing apparatus is configured to generate routing instructions based on the user-defined threshold.

6. The system of claim 1, wherein the routing interface is accessible to a user operating remotely from the vehicle, including during pre-trip planning or centralized route configuration.

7. The system of claim 1, wherein the routing interface is accessible to a vehicle operator or passenger from within the vehicle during operation.

8. The system of claim 1, wherein the routing interface comprises a graphical user interface (GUI), and the data processing apparatus is configured to present, in the GUI, a representation of at least some of the road segments of the route annotated with the associated risk labels.

9. The system of claim 8, wherein the GUI is configured to display corresponding exposure and avoidance durations associated with each risk label.

10. The system of claim 9, wherein the GUI includes control elements configured to enable a user to adjust one or more of the avoidance durations corresponding to respective risk labels associated with at least one of the road segments of the route, and wherein the data processing apparatus is configured to generate a revised instruction based on the user-adjusted avoidance durations.

11. The system of claim 1, wherein the routing interface comprises a graphical user interface including a plurality of adjustable interface elements corresponding to distinct risk labels, each configured to receive a user-defined tolerance level for a respective risk label,
and wherein the graphical user interface includes a visual feedback component configured to present, for each of the risk labels, an aggregate indication of temporal avoidance incurred over the route based on the user-defined tolerance level.

12. The system of claim 1, wherein the vehicle is an autonomous vehicle (AV), the vehicle includes onboard AV controller circuitry, and the routing interface is in communication with a network interface configured to direct communications between the onboard AV controller circuitry and the data processing apparatus.

13. The system of claim 1, wherein the data processing apparatus is implemented locally on the vehicle, remotely at a computing system external to the vehicle, or in a distributed arrangement across multiple computing systems.

14. The system of claim 1, wherein the data processing apparatus is configured to produce the road-segment risk-perception information by:
transforming geographic data of the geographic region into a plurality of risk-feature maps, each corresponding to a respective type of risk;
determining, for each road segment of the geographic region, an expected travel duration;
intersecting the road segments with risk features defined by the risk-feature maps; and
assigning, to each of the road segments, one or more risk labels and, for each assigned risk label, a corresponding exposure duration and a corresponding risk tolerance.

15. The system of claim 14, wherein the operation of transforming geographic data includes generating risk-feature maps by:
converting raw geospatial data into one or more of point-based, line-based, or area-based features corresponding to respective types of risk, and
applying spatial data processing operations specific to the feature type, including:
generating buffer zones to identify road segments within a proximity-based risk region; and
applying heat-map thresholds to determine zones of elevated risk severity.

16. The system of claim 15, wherein at least one spatial data processing operation is configured based on a user-defined parameter selected from a buffer radius, a proximity threshold, or a severity threshold, the parameter being associated with a specific type of risk.

17. The system of claim 15, wherein the risk-feature maps are used by the data processing apparatus to assign risk labels to road segments and to generate route evaluation scores that incorporate risk-related criteria in addition to travel-time optimization.

18. The system of claim 14, wherein the expected travel duration for each road segment is determined based on segment geometry and one or more traversal parameters including at least one of speed limits, average travel times, and vehicle-specific constraints.

19. The system of claim 14, wherein the operation of intersecting the road segments with risk features includes, for each road segment, determining whether the segment overlaps with one or more risk features represented in the risk-feature maps, and in response to an overlap:
assigning a corresponding risk label to the segment; and
for at least some overlapping non-point risk features, subdividing the road segment into risk-specific sub-segments to ensure alignment with the extent of the overlapping risk feature.

20. The system of claim 19, wherein the subdivision of road segments is performed by:
identifying a boundary of the risk feature that partially intersects a given road segment;
generating one or more sub-segments such that at least one sub-segment is fully contained within the boundary of the risk feature; and
associating each sub-segment with a corresponding portion of exposure duration based on the risk feature's characteristics.

21. The system of claim 1, wherein the data processing apparatus is configured to determine, for a plurality of connected road segments sharing a common risk label, an exposure duration representing a total continuous time of risk exposure, and to assign, to each road segment, a corresponding temporal avoidance value.

22. The system of claim 21, wherein the temporal avoidance value assigned to each road segment is:
proportional to that segment's expected travel duration relative to the total exposure duration across all segments associated with the same risk label; or
a predefined fixed value for segments intersecting a point-based risk feature associated with that label.

23. The system of claim 1, wherein the data processing apparatus is configured to associate each original road segment with a temporal avoidance value derived from a plurality of risk-specific sub-segments that were previously generated based on intersections with risk features.

24. The system of claim 23, wherein the temporal avoidance value assigned to an original road segment comprises a summation of temporal avoidance values of the corresponding sub-segments associated with that road segment.

25. The system of claim 23, wherein each original road segment is assigned a risk profile comprising a plurality of risk labels, corresponding exposure durations, and associated temporal avoidance values aggregated from the risk-specific sub-segments.

26. A method for managing road transportation of sensitive materials through a geographic region, the method comprising:
storing, in a memory, road-segment risk-perception information including, for each of a plurality of road segments of the geographic region, one or more risk labels identifying respective types of risk to which the sensitive materials would be exposed while being transported over the road segment;
receiving, via a routing interface, from a user, a request for information related to a route along which a vehicle is to transport the sensitive materials, the route comprising a plurality of the road segments of the geographic region, wherein at least some of the road segments are individually avoidable by exiting the route at one end of the road segment and rejoining the route at the other end after traveling along one or more off-route roads;
accessing, using a data processing apparatus, the route-related request;
retrieving, from the memory, a portion of the road-segment risk-perception information associated with the route;
generating, based on the retrieved portion, an instruction for operating the vehicle to transport the sensitive materials along the route; and
outputting the instruction to the routing interface for use by the vehicle operator.

27. The method of claim 26, including:
for each risk label associated with a given road segment, storing a corresponding exposure duration representing an expected amount of time of risk exposure, and a corresponding avoidance duration representing an estimated time to traverse an alternative route segment to avoid the risk;
wherein generating the instruction comprises comparing, for at least some of the road segments, the exposure duration and avoidance duration.

28. The method of claim 26, including:
for each risk label associated with a given road segment, storing an ordinal value on an acceptability scale representing a degree of perceived risk relative to other risk labels;
wherein generating the instruction comprises comparing at least some of the ordinal values to one or more thresholds associated with route selection criteria.

29. The method of claim 28, including:
associating each ordinal value with a statistical range derived from multiple evaluations of perceived risk for the corresponding risk label; and
presenting, via the routing interface, the statistical range to a user.

30. The method of claim 29, including:
displaying the statistical range for each risk label to facilitate user selection of a personalized threshold value on the acceptability scale, wherein the statistical range reflects variation in perceived risk collected from multiple sources; and
generating routing instructions based on the user-defined threshold.

31. The method of claim 26, including enabling the routing interface to be accessed by a user operating remotely from the vehicle during pre-trip planning or centralized route configuration.

32. The method of claim 26, including enabling the routing interface to be accessed from within the vehicle by a vehicle operator or passenger during operation.

33. The method of claim 26, including presenting, in a graphical user interface, a representation of at least some of the road segments of the route annotated with associated risk labels.

34. The method of claim 33, including displaying, in the graphical user interface, corresponding exposure durations and avoidance durations for each risk label.

35. The method of claim 34, including
enabling a user to adjust one or more of the avoidance durations via control elements; and
regenerating the instruction based on the user-adjusted avoidance durations.

36. The method of claim 26, including:
presenting a plurality of adjustable interface elements in the graphical user interface, each corresponding to a distinct risk label and configured to receive a user-defined tolerance level; and
displaying a visual feedback component indicating, for each risk label, an aggregate amount of temporal avoidance incurred based on the user-defined tolerance level.

37. The method of claim 26, wherein the vehicle is an autonomous vehicle, and the instruction is communicated via a network interface to onboard autonomous vehicle controller circuitry.

38. The method of claim 26, wherein the data processing apparatus is implemented locally on the vehicle, remotely in an external computing system, or in a distributed configuration.

39. The method of claim 26, including:
producing the road-segment risk-perception information by:
transforming geographic data of the geographic region into a plurality of risk-feature maps, each corresponding to a respective type of risk;
determining, for each road segment, an expected travel duration;
intersecting the road segments with risk features defined in the risk-feature maps; and
assigning, to each road segment, one or more risk labels and, for each assigned risk label, a corresponding exposure duration and a corresponding risk tolerance.

40. The method of claim 39, wherein generating the risk-feature maps includes:
converting raw geospatial data into one or more of point-based, line-based, or area-based features for respective types of risk; and
applying spatial data processing operations, including generating buffer zones and applying heat-map thresholds.

41. The method of claim 39, wherein the risk-feature maps include a plurality of risk indicators derived from one or more of: security risk, service availability risk, and mission-defined risk.

42. The method of claim 39, wherein at least one spatial data processing operation is configured using a user-defined parameter selected from a buffer radius, proximity threshold, or severity threshold associated with a specific type of risk.

43. The method of claim 39, including assigning route evaluation scores to road segments based on risk-related criteria in addition to travel-time optimization.

44. The method of claim 39, including:
for a plurality of connected road segments sharing a common risk label, determining a total continuous exposure duration; and
assigning to each segment a temporal avoidance value based on its expected travel duration or a fixed avoidance value for point-based risks.

45. The method of claim 39, including:
associating each original road segment with a temporal avoidance value derived from risk-specific sub-segments; and
generating, for each original segment, a risk profile comprising a plurality of risk labels, exposure durations, and corresponding temporal avoidance values aggregated from the sub-segments.
